(19) United States
(12) Patent Application Publication
(10) Pub. No.: US 2025/0363375 A1
(43) Pub. Date: Nov. 27, 2025

(54) TRAINING NEURAL NETWORK TROUGH MANY-TO-ONE KNOWLEDGE INJECTION

(71) Applicant: Intel Corporation, Santa Clara, CA (US)

(72) Inventors: Xiaolong Liu, Beijing (CN); Anbang Yao, Beijing (CN); Yi Qian, Shanghai (CN); Jiaojiao Lin, Shanghai (CN); Yurong Chen, Beijing (CN)

(21) Appl. No.: 18/997,968

(22) PCT Filed: Aug. 26, 2022
(86) PCT No.: PCT/CN2022/114972

§ 371 Date: Jan. 23, 2025

(51) Int. Cl. G06N 3/09; G06N 3/0464

(52) U.S. Cl. CPC G06N 3/09; G06N 3/0464

(57) ABSTRACT

A target neural network can be trained with a support neural network through many-to-one knowledge injection. The many-to-one knowledge injection is facilitated by two layers inserted into the target neural networks. The first layer converts a target OFM in the target neural network into an expanded feature map having more channels. The second layer converts the expanded feature map to a new feature map having the same dimensions as the target OFM. The expanded feature map can be divided into segments, each of which has the same number of channels as a support OFM in the support neural network so that the knowledge in the support OFM can be injected into each of the segment through a many-to-one injection. To train the target neural network, parameters inside the target neural network are modified to minimize a feature distance between the expanded feature map and the support OFM.

### TECHNICAL FIELD

This disclosure relates generally to neural networks, and more specifically, to training deep neural networks (DNNs) through many-to-one knowledge injection.

### BACKGROUND

DNNs are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as each inference can require hundreds of millions of MAC (multiply-accumulate) operations as well as hundreds of millions of weight operand weights to be stored for classification or detection. Therefore, techniques to improve efficiency of DNNs are needed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example layer structure of a DNN, in accordance with various embodiments.

FIG. 2 is a block diagram of a DNN system, in accordance with various embodiments.

FIG. 3 is a block diagram of a training module, in accordance with various embodiments.

FIG. 4 illustrates an example process of training a student network with a teacher network through many-to-one knowledge injection, in accordance with various embodiments.

FIG. 5 illustrates an example process of training a student network with a teacher network through many-to-one knowledge injection, in accordance with various embodiments.

FIG. 6 illustrates a deep learning (DL) environment, in accordance with various embodiments.

FIG. 7 is a flowchart showing a method of training a DNN through knowledge distillation, in accordance with various embodiments.

FIG. 8 is a block diagram of an example computing device, in accordance with various embodiments.

### DETAILED DESCRIPTION

### Overview

DNNs are widely used in the domains of computer vision, speech recognition, image, and video processing mainly due to their ability to achieve beyond human-level accuracy. However, the improvements in accuracy come at the expense of significant computation cost. The underlying DNNs have extremely high computing demands as each input requires at least hundreds of millions of MAC operations as well as hundreds of millions of weight operand weights to be processed for classification or detection. Energy constrained mobile systems and embedded systems, where energy and area budgets are extremely limited, often use area and energy efficient DNN accelerators as the underlying hardware for executing machine learning applications.

Knowledge distillation is one of the solutions that provides a teacher-student training framework to train a compact, computationally efficient DNN model having improved predication accuracy compared to the standard training. However, many existing knowledge distillation solutions have various limitations. For instance, these solutions usually use feature maps, attention maps, and abstracted feature forms at multiple hidden layers as the knowledge representation. Due to different network depth and layer width, the output feature maps of a teacher-student layer pair usually have different dimensions. To align the feature dimension, these solutions perform a variety of teacher/student transforms. However, such transform designs cause different levels of information loss due to feature dimension reduction. Furthermore, many existing knowledge distillation methods (in both two-stage and one-stage families) usually adopt the one-to-one representation matching between every pre-selected teacher-student layer pair. That is, there is one knowledge transfer inlet for any teacher-student layer pair, which sometimes cannot efficiently transfer knowledge from teacher to student. Therefore, improved techniques for knowledge distillation are needed.

Embodiments of the present disclosure may improve on at least some of the challenges and issues described above by providing methods and apparatus that facilitate knowledge distillation through many-to-one knowledge injection, which is also referred to N-to-1 knowledge injection, where N represents an integer greater than 1.

In some embodiments of the present disclosure, a target neural network is trained by getting knowledge from a support neural network. The target neural network may be referred to as a student neural network, a student network, or student. The support neural network may be referred to as a teacher neural network, teacher network, or teacher. The support neural network has been trained. Knowledge learnt by the support neural network may be represented by one or more feature maps inside the support neural network, e.g., an output feature map (OFM) of a convolutional layer in the support neural network. The convolutional layer in the support neural network may correspond to a convolutional layer in the target neural network, e.g., the two layers are aligned or the stages in which the two layers are included are aligned. Knowledge learnt by the convolutional layer in the support neural network can be transferred to the convolutional layer in the target neural network through many-to-one knowledge injection. The convolutional layer in the support neural network may be referred as the teacher layer. The convolutional layer in the target neural network may be referred as the student layer.

The many-to-one knowledge injection may be facilitated by two layers inserted into the target neural networks. The two layers may be placed right after the student layer. The first layer can convert an OFM of the student layer into an expanded feature map that has more channels. The OFM of the student layer may be referred to as a student feature map. The second layer can convert the expanded feature map to a new feature map having the same dimensions as the student feature map. The expanded feature map can be divided into segments, each of which has the same number of channels as an OFM of the teacher layer (“teacher feature map”) so that the knowledge in the teacher feature map can be injected into each of the segment through a many-to-one injection. The target neural network can be trained by modifying parameters inside the target neural network to minimize a feature distance between the expanded feature map and the teacher feature map. After the target neural network is trained, the two layers can be merged into a layer arranged after the student layer in the target neural network, such as a fully-connected layer.

Compared with existing knowledge distillation solutions that uses one-to-one knowledge injection, the many-to-one knowledge injection can be used to train various types of DNNs with better accuracy and efficiency tradeoff. These DNNs can be used in various AI (artificial intelligence) applications such as image classification, face recognition, action recognition, person re-identification, machine translation and speech recognition. The present disclosure provides a knowledge distillation solution that can preserve intact information learnt by the pre-trained teacher network and convert computationally intensive DNNs into more lightweight ones with similar accuracy. From a hardware perspective, this can facilitate replacement of deep, sequential processing with parallel, distributed processing. This structural conversion can enable the acceleration of DNN training and inference using general-purpose-processors (GPPs), such as multi-core central processing units (CPUs) and graphics processing units (GPUs).

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed, or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The DNN systems, methods and devices of this disclosure each have several innovative aspects, no single one of which is solely responsible for all desirable attributes disclosed herein. Details of one or more implementations of the subject matter described in this specification are set forth in the description below and the accompanying drawings.

### Example DNN Layer Structure

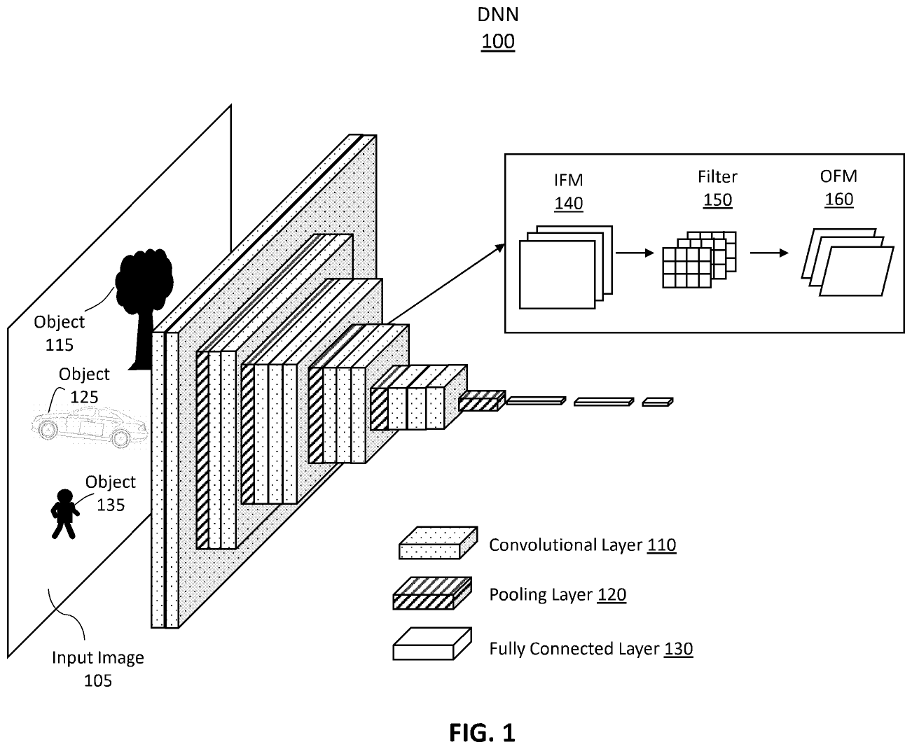

FIG. 1 illustrates an example layer structure of a DNN 100, in accordance with various embodiments. For purpose of illustration, the DNN 100 in FIG. 1 is a convolutional neural network (CNN). In other embodiments, the DNN 100 may be other types of DNNs. The DNN 100 is trained to receive images and output classifications of objects in the images. In the embodiment of FIG. 1, the DNN 100 receives an input image 105 that includes objects 115, 125, and 135. The DNN 100 includes a sequence of layers comprising a plurality of convolutional layers 110 (individually referred to as “convolutional layer 110”), a plurality of pooling layers 120 (individually referred to as “pooling layer 120”), and a plurality of fully-connected layers 130 (individually referred to as “fully-connected layer 130”). In other embodiments, the DNN 100 may include fewer, more, or different layers.

The convolutional layers 110 summarize the presence of features in the input image 105. In the embodiment of FIG. 1, the first layer of the DNN 100 is a convolutional layer 110. The convolutional layers 110 function as feature extractors. A convolutional layer 110 can receive an input and outputs features extracted from the input. In an example, a convolutional layer 110 performs a convolution to an IFM (input feature map) 140 by using a filter 150, generates an OFM 160 from the convolution, and passes the OFM 160 to the next layer in the sequence. The IFM 140 may include a plurality of IFM matrices. The filter 150 may include a plurality of weight matrices. The OFM 160 may include a plurality of OFM matrices. For the first convolutional layer 110, which is also the first layer of the DNN 100, the IFM 140 is the input image 105. For the other convolutional layers, the IFM 140 may be an output of another convolutional layer 110 or an output of a pooling layer 120.

A convolution may be a linear operation that involves the multiplication of a weight operand in the filter 150 with a weight operand-sized patch of the IFM 140. A weight operand may be a weight matrix in the filter 150, such as a 2-dimensional array of weights, where the weights are arranged in columns and rows. Weights can be initialized and updated by backpropagation using gradient descent. The magnitudes of the weights can indicate importance of the filter 150 in extracting features from the IFM 140. A weight operand can be smaller than the IFM 140. The multiplication can be a element-wise multiplication between the weight operand-sized patch of the IFM 140 and the corresponding weight operand, which is then summed, always resulting in a single value. Because it results in a single value, the operation is often referred to as the “scalar product.”

In some embodiments, using a weight operand smaller than the IFM 140 is intentional as it allows the same weight operand (set of weights) to be multiplied by the IFM 140 multiple times at different points on the IFM 140. Specifically, the weight operand is applied systematically to each overlapping part or weight operand-sized patch of the IFM 140, left to right, top to bottom. The result from multiplying the weight operand with the IFM 140 one time is a single value. As the weight operand is applied multiple times to the IFM 140, the multiplication result is a two-dimensional array of output values that represent a weight operanding of the IFM 140. As such, the 2-dimensional output array from this operation is referred to a “feature map.”

In some embodiments, the OFM 160 is passed through an activation function. An example activation function is the rectified linear activation function (ReLU). ReLU is a calculation that returns the value provided as input directly, or the value zero if the input is zero or less. The convolutional layer 110 may receive several images as input and calculates the convolution of each of them with each of the weight operands. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layers 110 performs a convolution on the OFM 160 with new weight operands and generates a new feature map. The new feature map may also be normalized and resized. The new feature map can be weight operanded again by a further subsequent convolutional layer 110, and so on.

In some embodiments, a convolutional layer 110 has four hyperparameters: the number of weight operands, the size F weight operands (e.g., a weight operand is of dimensions F×F×D pixels), the S step with which the window corresponding to the weight operand is dragged on the image (e.g., a step of one means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depth-wise separable convolution, transposed convolution, and so on. The DNN 100 includes 16 convolutional layers 110. In other embodiments, the DNN 100 may include a different number of convolutional layers.

The pooling layers 120 down-sample feature maps generated by the convolutional layers, e.g., by summarizing the presents of features in the patches of the feature maps. A pooling layer 120 is placed between two convolutional layers 110: a preceding convolutional layer 110 (the convolutional layer 110 preceding the pooling layer 120 in the sequence of layers) and a subsequent convolutional layer 110 (the convolutional layer 110 subsequent to the pooling layer 120 in the sequence of layers). In some embodiments, a pooling layer 120 is added after a convolutional layer 110, e.g., after an activation function (e.g., ReLU) has been applied to the OFM 160.

A pooling layer 120 receives feature maps generated by the preceding convolutional layer 110 and applies a pooling operation to the feature maps. The pooling operation reduces the size of the feature maps while preserving their important characteristics. Accordingly, the pooling operation improves the efficiency of the DNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of two pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3. The output of the pooling layer 120 is inputted into the subsequent convolutional layer 110 for further feature extraction. In some embodiments, the pooling layer 120 operates upon each feature map separately to create a new set of the same number of pooled feature maps.

The fully-connected layers 130 are the last layers of the DNN. The fully-connected layers 130 may be convolutional or not. The fully-connected layers 130 receives an input operand. The input operand defines the output of the convolutional layers 110 and pooling layers 120 and includes the values of the last feature map generated by the last pooling layer 120 in the sequence. The fully-connected layers 130 applies a linear combination and an activation function to the input operand and generates an individual partial sum. The individual partial sum may contain as many elements as there are classes: element i represents the probability that the image belongs to class i. Each element is therefore between 0 and 1, and the sum of all is worth one. These probabilities are calculated by the last fully-connected layer 130 by using a logistic function (binary classification) or a softmax function (multi-class classification) as an activation function.

In some embodiments, the fully-connected layers 130 classify the input image 105 and returns an operand of size N, where N is the number of classes in the image classification problem. In the embodiment of FIG. 1, N equals 3, as there are three objects 115, 125, and 135 in the input image. Each element of the operand indicates the probability for the input image 105 to belong to a class. To calculate the probabilities, the fully-connected layers 130 multiply each input element by weight, makes the sum, and then applies an activation function (e.g., logistic if N=2, softmax if N>2). This is equivalent to multiplying the input operand by the matrix containing the weights. In an example, the individual partial sum includes three probabilities: a first probability indicating the object 115 being a tree, a second probability indicating the object 125 being a car, and a third probability indicating the object 135 being a person. In other embodiments where the input image 105 includes different objects or a different number of objects, the individual partial sum can be different.

### Example DNN System

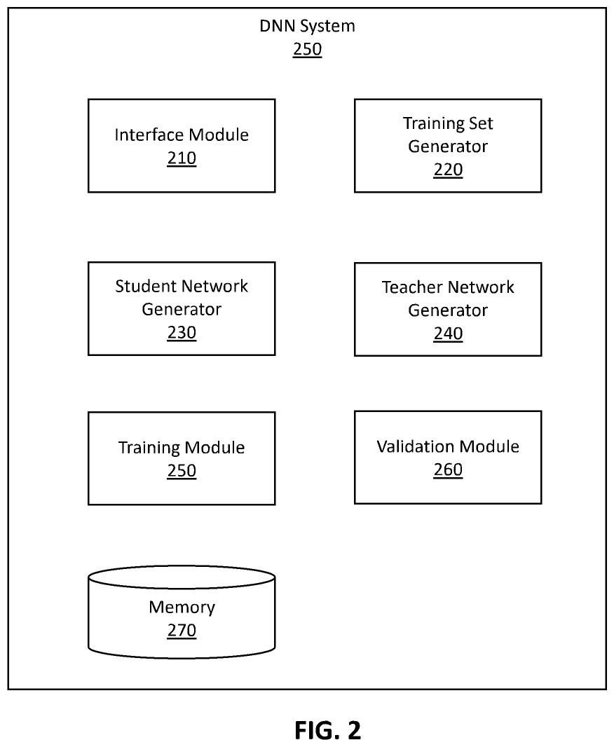

FIG. 2 is a block diagram of a DNN system 200, in accordance with various embodiments. The DNN system 200 trains DNNs by using knowledge distillation, e.g., knowledge distillation with many-to-one knowledge injection. A DNN can be used to perform one or more machine learning tasks. A machine learning task is a task of making an inference. The inference is a process of running available data into the DNN to generate an output, and the output provides a solution to a problem or question that is being asked. An example of the output is one or more numerical scores that can indicate a probability of an object in an image belonging to a category. The DNN system 200 can train DNNs that can be used to solve various problems, such as image classification, learning relationships between biological cells (e.g., DNA, proteins, etc.), control behaviors for devices (e.g., robots, machines, etc.), and so on.

The DNN system 200 includes an interface module 210, a training set generator 220, a student network generator 230, a teacher network generator 240, a training module 250, a validation module 260, and a memory 270. In other embodiments, alternative configurations, different or additional components may be included in the DNN system 200. Further, functionality attributed to a component of the DNN system 200 may be accomplished by a different component included in the DNN system 200 or by a different system.

The interface module 210 facilitates communications of the DNN system 200 with other systems. For example, the interface module 210 establishes communications between the DNN system 200 with an external database to receive data that can be used to train DNNs or data that can be input into DNNs to perform machine learning tasks. As another example, the interface module 210 supports the DNN system 200 to distribute DNNs to other systems, e.g., computing devices configured to apply DNNs to perform tasks. The computing devices may be an edge device, a client device, and so on.

The training set generator 220 forms training datasets that will be used to train DNNs. A training dataset includes training samples and ground-truth labels. The training dataset may include one or more ground-truth labels for each training sample. A ground-truth label of a training sample may be a known or verified label that answers the problem or question that the DNN will be used to answer. In an example where a DNN is trained to recognize objects in images, the training dataset includes training images and ground-truth labels that indicate classifications of objects in the training images. A ground-truth label in the example may be a number that indicates a probability that an object belongs to a class. The object may be associated with other ground-truth labels that indicate probabilities that the object belongs to other classes.

In some embodiments, the training set generator 220 may also form validation datasets for validating performance of trained DNNs by the validation module 260. A validation dataset may include validation samples and ground-truth labels of the validation samples. The validation dataset for a DNN may include different samples from the training dataset used for training the DNN. In an embodiment, a part of a training dataset may be used to initially train a DNN, and the rest of the training dataset may be held back as a validation subset used by the validation module 260 to validate performance of the trained DNN. The portion of the training dataset not including the validation subset may be used to train the DNN.

The student network generator 230 generates student networks. A student network is a DNN that after trained, can be used to perform machine learning tasks. The student network generator 230 may generates a student network based on parameters that define the architecture of a DNN. Examples of the parameters include the number of layers, types of layers, sequence of layers, number of processing elements (PEs) in a layer, types of PEs, arrangement of PEs (e.g., interconnections between PEs, number of columns in a PE array, number of rows in a PE array, etc.) in a layer, activation function, pooling function, or other types of parameters. A processing element performs MAC operations.

In some embodiments, the student network generator 230 determines some or all of the parameters, e.g., based on the problem or question to be answered by the DNN, resource available for training, resources available for inference, some other factors that may be critical to the architecture of the DNN, or some combination thereof. In other embodiments, the student network generator 230 may receive some or all of the parameters from a different system (e.g., from a computing device that will run the DNN for inference, a system managing such computing devices, etc.) or from a user (e.g., through a user interface that allows the user to provide information of the DNN).

The architecture of a DNN includes an input layer, an output layer, and a plurality of hidden layers. The input layer of a DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as rectified liner unit (ReLU) layers, pooling layers, fully-connected layers, normalization layers, softmax or logistic layers, and so on. The convolutional layers of the DNN abstract the input image to a feature map that is represented by a tensor specifying the feature map height, the feature map width, and the feature map channels (e.g., red, green, blue images include three channels). A pooling layer is used to reduce the spatial volume of input image after convolution. It is used between two convolutional layers. A fully-connected layer involves weights, biases, and neurons. It connects neurons in one layer to neurons in another layer. It is used to classify images between different category by training. An example DNN is the DNN 100 described above in conjunction with FIG. 1.

The teacher network generator 240 generates teacher networks to be used to train student networks through knowledge distillation. In some embodiments, the teacher network generator 240 may generate a single teacher network for training a single student network or multiple student networks, or may generate multiple teacher networks to train a single student network. A teacher network may be a DNN. A teacher network may have a different architecture from a student network trained with the teacher network. For instance,

In some embodiments, the teacher network generator 240 determines a structure of a teacher network based on the structure of a student network. For instance, the teacher network generator 240 may generate a teacher network including the same number and/or types of layers as the student network. The arrangement of the layers in the teacher network (“teacher layers”) can be the same as the arrangement of the layers in the student network (“student layers”). Also, for an individual teacher layer, the teacher network generator 240 may design the teacher layer based on a corresponding student layer. The teacher network generator 240 may make the teacher layer mirror the student layer. For instance, the teacher layer can have the same number and/or types of PEs as the student layer. The arrangement of the PEs can also be the same in the two layers.

The teacher network generator 240 also generates internal connections within the teacher network. An internal connection may connect two teacher layers, e.g., from a first teacher layer to a second teacher layer. The second teacher layer may be arranged in after the first layer in the teacher network. The internal connection facilitates data transfer between the two teacher layers. For instance, the first layer can send features (e.g., OFM 160) to the second layer through the internal connection. The second layer receives the features and can aggregate the features from the first layer with features generated in the second layer to output aggregated features. An internal connection may be bi-directional, e.g., the second layer can also send data to the first layer.

The training module 250 trains DNNs, such as student networks, through many-to-one knowledge injection from student networks. The training module 250 can generate student transformation layers and insert these layers into a student network. In some embodiments, the training module 250 places the student transformation layers after a convolutional layer in the student network, e.g., the last convolutional layer in the student network. The student transformation layers facilitate many-to-one knowledge injection from a teacher network, e.g., from a feature map in the teacher network, during the training of the student network.

One of the student transformation layers can convert a feature map output from the convolutional layer in the student network into an expanded feature map. The expanded feature map includes more channels than the student feature map, but the pixels in each channel in the expanded feature map may be the same as the pixels in each channel in the student feature map. The expanded feature map includes a plurality of segments, each segment has the same number of channels as the teacher feature map. The training module 250 may modify internal parameters in the student network so that each segment of the expanded feature map may be similar or same as the teacher feature map. As there are many segments in the expanded feature map and one teacher feature map in this process, the knowledge injection in this process is many-to-one knowledge injection.

The other layer of the student transformation layers can convert the expanded feature map to a new feature map that includes the same number of channels as the student feature map, so that the new feature map can be fed into and processed by the next layer in the student network without disrupting the operation in the next layer.

In addition to injecting knowledge from the teacher feature map into the student feature map, the training module 250 can train the student network further based on a training set. The training module 250 may also receive training datasets from the training set generator 220. The training module 250 can send training samples in a training dataset to the student network. The training module 250 modifies the parameters inside the student network to minimize the error between labels of the training samples that are generated by the student network and the ground-truth labels in the data set. The training module 250 may use a loss function, e.g., a cross-entropy loss function, to minimize the error. In some embodiments, the training module 250 modifies the parameters inside the student network to minimize a combination of a difference between the teacher feature map and the expanded feature map and a difference between the labels generated by the student network and the ground-truth labels.

The training module 250 may stop adjusting the parameters in the merged network after a threshold condition is met. The threshold condition may be that a predetermined number of epochs are done, a target performance (e.g., an accuracy) of the merged, student, or teacher network is met, or other types of conditions. The trained student network can be used to handle machine learning tasks. In some embodiments, the student network, or parameters of the student network, may be sent to another system or device (e.g., an edge device, a client device, etc.) for inference.

The training module 250 may also determine hyperparameters for the training process. Hyperparameters may be different from parameters inside the network (e.g., weights). In some embodiments, the hyperparameters include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the DL algorithm works through the entire training dataset. One epoch means that each training sample in the training dataset has had an opportunity to update the parameters inside the network. An epoch may include one or more batches. The number of epochs may be 10, 100, 500, 1000, or even larger.

The validation module 260 verifies performance (e.g., accuracy) of trained DNNs, such as trained student networks that are separated from their corresponding teacher networks. The validation module 260 may determine an accuracy of a trained student network and determines whether the accuracy meets a threshold (e.g., a requirement for model accuracy). In response to determining that the accuracy of the student network meets the threshold, the validation module 260 may deploy the student network to another system or device, e.g., through the interface module 210. In some embodiments, the validation module 260 may also verify performance of merged networks or teacher networks. For instance, the validation module 260 determines whether an accuracy of a merged network meets a threshold. In response to determining that the accuracy does not meet the threshold, the validation module 260 may instruct the training module 250 to further train the merged network. In response to determining that the accuracy meets the threshold, the validation module 260 may notify the training module 250 that the merged network has been sufficiently trained or instruct the training module 250 to separate the student network from the teacher network.

In some embodiments, the validation module 260 inputs samples in a validation dataset into the DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validation module 260 determines may determine an accuracy score measuring the precision, recall, or a combination of precision and recall of the DNN. The validation module 260 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The memory 270 stores data associated with the DNN system 200, such as data received, generated, or used by the DNN system 200. For instance, the memory 270 may store parameters (e.g., internal parameters, hyperparameters, etc.) of student networks or teacher networks generated by the student network generator 230, the teacher network generator 240, or the training module 250. The memory 270 may also store training sets and validation sets used to train networks and validate networks. In some embodiments, the DNN system 200 may be associated with multiple memories. The memory 270 may include a random-access memory (RAM), such as a static RAM (SRAM), disk storage, nearline storage, online storage, offline storage, and so on.

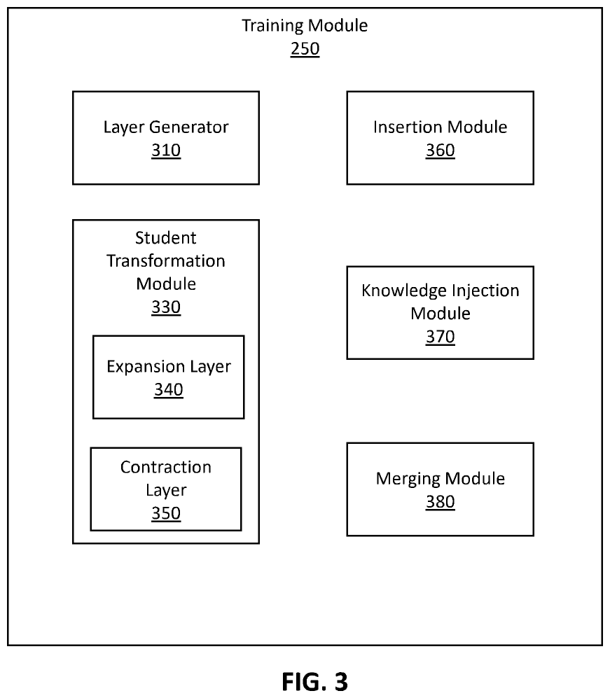

FIG. 3 is a block diagram of the training module 250, in accordance with various embodiments. The training module 250 includes a layer generator 310, a student transformation module 330 including an expansion layer 340 and a contraction layer 350, an insertion module 360, a knowledge injection module 370, and a merging module 380. In other embodiments, alternative configurations, different or additional components may be included in the training module 250. For instance, the training module 250 may include multiple student transformation modules. Further, functionality attributed to a component of the training module 250 may be accomplished by a different component included in the training module 250 or by a different system.

The layer generator 310 generates the expansion layer 340 and contraction layer 350 in the student transformation module 330. The expansion layer 340 can expand a feature map Fₛ in a student network and generates an expanded feature map. The expanded feature map Fₛₑ may include more channels than the feature map Fₛ, but the spatial size of the expanded feature map Fₛₑ in each channel may be the same as the spatial size of the feature map Fₛ in each channel. For instance, the feature map Fₛ may include the same number of pixels in each channel as the expanded feature map Fₛₑ.

In some embodiments, the layer generator 310 generates the expansion layer 340 by defining a convolutional kernel Wₛₑ for the expansion layer 340. The expansion layer 340 may perform a convolutional operation based on the feature map Fₛ and the convolutional kernel Wₛₑ to generate the expanded feature map Fₛₑ, e.g., Fₛₑ=Wₛₑ* Fₛ, where * denotes the convolution operation. The layer generator 310 may determine the convolutional kernel based on the feature map in the student network and a corresponding feature map in the teacher network. In an example where the number of channels in the student feature map is Cₛ (e.g., Fₛ∈ [symbol] ^{H×W×C}^{ₛ}) and the number of channels in the teacher feature map is Cₜ (e.g., Fₜ∈ [symbol] ^{H×W×C}^{ₜ}), the convolutional kernel Wₛₑ may be a 1×1 convolutional kernel Wₛₑ∈ [symbol] ^{1×1×C}^{ₛ}^{×NC}^{ₜ} along the channel dimension to project each pixel in Fₛₑ to a desired channel dimension NCₜ, producing an expanded student representation Fₛₑ∈ [symbol] ^{H×W×NC}^{ₜ} having N times feature channels than that of the teacher feature map.

The layer generator 310 can also generate the contraction layer 350 in the student transformation module 330. The layer generator 310 may the contraction layer 350 by defining another convolutional kernel W_{sc}. The convolutional kernel W_{sc} may be another 1×1 convolutional kernel, e.g., W_{sc}∈ [symbol] ^{1×1×NC}^{ₜ}^{×C}^{ₛ}. The contraction layer 350 may perform a convolutional operation on the expanded feature map Fₛₑ and the convolutional kernel W_{sc} to convert the expanded feature map Fₛₑ back to the original channel dimension Cₛ, producing F_{sc}∈ [symbol] ^{H×W×N}^{ₛ}, which may be denoted as Fₛₑ=Wₛₑ*Fₛ, F_{sc}=W_{sc}*Fₛₑ, where * denotes the convolution operation.

The insertion module 360 inserts the student transformation module 330 into the student network. In some embodiments, the insertion module 360 inserts the student transformation module 330 after a convolutional layer in the student network. The student feature map Fₛ is the output of the convolutional layer. The convolutional layer may be the last convolutional layer in the student network. Similarly, the teacher feature map Fₜ may be the output of the last convolutional layer in the teacher network, so that by training the student transformation module 330 based on the teacher feature map Fₜ, the student network can obtain the knowledge in the last convolutional layer in the teacher network, which can incorporate knowledge in all the precedent convolutional layers in the teacher network. In other embodiments, the student transformation module 330, or an additional student transformation module 330, may be inserted after a convolutional layer that is not the last convolution layer in the student network. In the process of inserting the student transformation module 330 into the student network, the insertion module 360 places the expansion layer 340 in front of the contraction layer 350.

The knowledge injection module 370 uses many-to-one knowledge injection to train the student network. In some embodiments, the knowledge injection module 370 split Fₛₑ into N non-overlapping segments

$${F}_{s e}^{i} ∈ {ℝ}^{H \times W \times {C}_{t}}$$

having the same number of feature channels. That way, the number of channels in each segment

$${F}_{s e}^{i}$$

equals the number of channels in the teacher feature map is Fₜ. Then the knowledge injection module 370 can force each individual segment

$${F}_{s e}^{i}$$

to approximate or even equal the teacher feature map is Fₜ. For instance, the knowledge injection module 370 may modify internal parameters of the student network (e.g., values in filters of convolutional layers in the student network) to reduce a difference between each segment

$${F}_{s e}^{i}$$

with the teacher feature map is Fₜ. The difference may be a L2-normed feature distance between a segment

$${F}_{s e}^{i}$$

and the teacher feature map is Fₜ.

Alternatively, the knowledge injection module 370 may modify internal parameters of the student network to reduce an overall difference between the whole expanded feature map Fₛₑ and the teacher feature map Fₜ. The overall difference may be an aggregation of feature distances between each of the segments

$${F}_{s e}^{i}$$

and the teacher feature map is Fₜ. The aggregation may be an average or an accumulation. In some embodiments, the knowledge injection module 370 defines a feature distance function:

$${L}_{n o r m} = \frac{1}{N} {\sum }_{i = 1}^{N} d ( {F}_{se}^{i} , {F}_{t} )$$

where d(

$${F}_{se}^{i} , {F}_{t} )$$

denotes the feature distance between a segment

$${F}_{se}^{i}$$

and the teacher feature map is Fₜ.

The knowledge injection module 370 may change the internal parameters of the student network to minimize Lₙₒᵣₘ, e.g., till the value of Lₙₒᵣₘ reaches a threshold. As the internal parameters of the student network changes, pixels in the student feature map Fₛ would have different values, and pixels in the expanded feature map Fₛₑ and each segment

$${F}_{s e}^{i}$$

would have different values. And the value of Lₙₒᵣₘ can be changed. As knowledge injection module 370 injects the knowledge in the teacher feature map Fₜ into N segments

$${F}_{se}^{i} ,$$

this knowledge distillation process includes N-to-1 knowledge injection.

The knowledge injection module 370 can modify the internal parameters of the student network further based on training samples and their ground-truth labels during the training of the student network. In some embodiments, the knowledge injection module 370 may modify the internal parameters of the student network to minimize Lₙₒᵣₘ, a loss between the ground-truth labels and determinations made by the student network based on the training samples, or a combination of both. For instance, the knowledge injection module 370 may train the student network by jointly minimizing the N-to-1 representation matching loss Lₙₒᵣₘ with a cross-entropy loss L_{ce} supervised by the ground-truth labels:

$$L = {L}_{n o r m} + {L}_{c e} .$$

In some embodiments, the expansion layer 340 and the contraction layer 350 can be trained simultaneously as other layers (e.g., the existing layers) in the student network.

The merging module 380 merges the student transformation module 330, after the student transformation module 330 is trained, into the student network. In some embodiments the merging module 380 may merge the student transformation module 330 into a layer that is subsequent to the convolutional layer outputting the student feature map Fₛ in the student network. The layer may be a fully-connected layer or another convolutional layer. In some embodiments, the layer may be the last fully-connected layer that outputs determinations of the student network. The learnt parameters of the fully-connected layer may be denoted as W_{fc}∈ [symbol] ^{C}^{ₛ}^{×C}^{_{fc}}. The merging module 380 may merge the student transformation module 330, which can be denoted as Tₛ(Wₛₑ, W_{sc}) into the fully-connected layer by: W_{fc}=W_{fc}(W_{sc}Wₛₑ).

### Example Processes of Training Student Networks

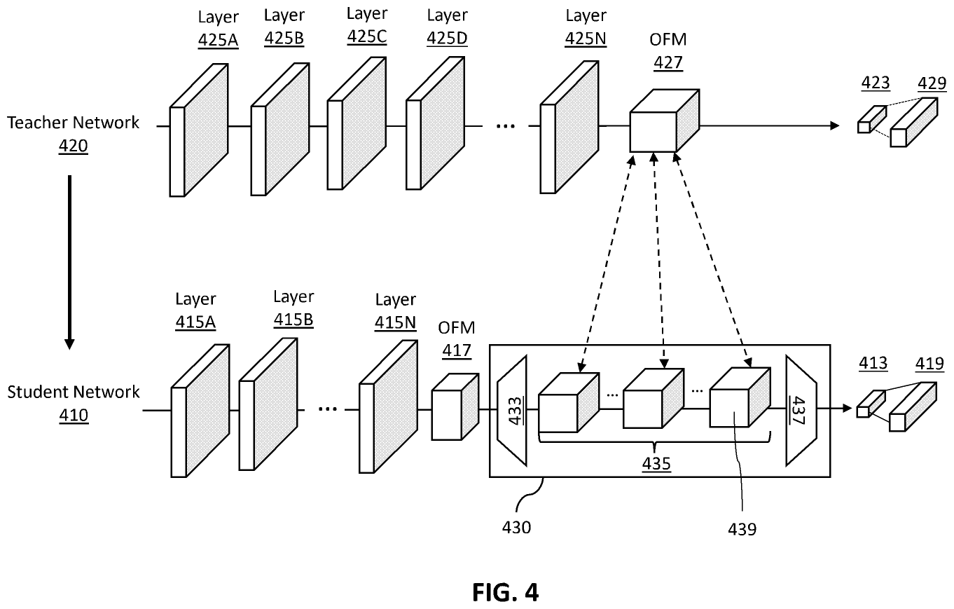

FIG. 4 illustrates an example process of training a student network 410 with a teacher network 420 through many-to-one knowledge injection, in accordance with various embodiments. The student network 410 may be provided by the student network generator 230. The formation of the teacher network 420 may be done by the teacher network generator 240. For purpose of simplicity and illustration, the student network 410 includes four layers 415A-415N (collectively referred to as “student layers 415” or “student layer 415”), and the teacher network 420 includes four layers 425A-425N (collectively referred to as “teacher layers 425” or “teacher layer 425”). The student layers 415 and teacher layers 425 may be convolutional layers, self-attention layers, linear layers, or some combination thereof. In other embodiments, the student network 410 or the teacher network 420 may include more, fewer, or different layers. For instance, the student network 410 or the teacher network 420 may include additional layers arranged between, before, or after the layers shown in FIG. 4.

In some embodiments, some or all of the teacher layers 425 may be aligned with some or all of the student layers 415, or stages in the teacher network 420 may be aligned with stages in the student network 410. A stage may include one or more layers. The teacher network 420 may include more or different layers from the student network 410. The teacher network 420 has been trained. The knowledge learnt by the teacher network 420 during the training can be injected into the student network 410 through a student transformation module 430.

As shown in FIG. 4, the student transformation module 430 is inserted into the student network 410. The student transformation module 430 may be an embodiment of the student transformation module 330 in FIG. 3. In the embodiment of FIG. 4, the student transformation module 430 is placed right after the layer 425N. The layer 425N is a convolutional layer that has an output of OFM 417. The layer 425N is the last convolutional layer in the student network 410. The student transformation module 430 includes an expansion layer 433 and a contraction layer 437. The expansion layer 433 converts the OFM 417 into an expanded feature map 435, which includes a group of segments 439 (individually referred to as “segment 439”). Each segment 439 has the same number of channels as an OFM 427 in the teacher network 420. The OFM 427 is an output of the layer 425N in the teacher network 420.

The layer 425N may be aligned with the layer 415N, or a stage including the layer 425N in the teacher network 420 aligns with a stage including the layer 415N in the student network 410. In some embodiments (e.g., embodiments where the layer 415N is the last convolutional layer in the student network 410), the layer 425N is the last convolutional layer in the teacher network 420. In the embodiment of FIG. 4, the layer 425N precedes a fully-connected layer 423 that outputs a label 429. The label 429 may represent a determination of the teacher network 420. The OFM 427 may include different values or have different dimensions from the OFM 417. It is considered that the OFM 427 has “better knowledge” than the OFM 417 and the “knowledge” in the OFM 427 may be injected into the OFM 417 in the process of training the student network 410 with the teacher network 420.

As shown in FIG. 4, the “knowledge” in the OFM 427 is injected into every segment 439 in the expanded feature map 435. As a segment 439 includes the same number of channels as the OFM 427, the knowledge injection can be performed by forcing each segment 439 to approximate the OFM 427. Such knowledge injection is performed on a N-to-1 basis and is referred to as N-to-1 knowledge injection. In some embodiments, the internal parameters of the student network 410, e.g., some or all filters in layers 415A-N, can be modified during the knowledge injection, e.g., based on a feature map function that aggregates feature distances between the OFM 427 and the segments 439.

The contraction layer 437 can convert the expanded feature map 435 back to the dimension of the OFM 417. The contraction layer 437 can generate a new feature map that has the same dimensions as the OFM 417 but different pixels. The new feature map can be fed into a fully-connected layer 413, which processes the new feature map and outputs a label 419. The label 419 may be a determination made by the student network 410. In some embodiments, the training of the student network 410 also includes a process of minimizing a difference between the label 419 and the ground-truth label of a training sample based on which the student network 410 generates the label 419. For instance, the internal parameters of the student network 410 based on modified to minimize a combination of the aggregated feature distance and the difference between the label 419 and the growth-truth label.

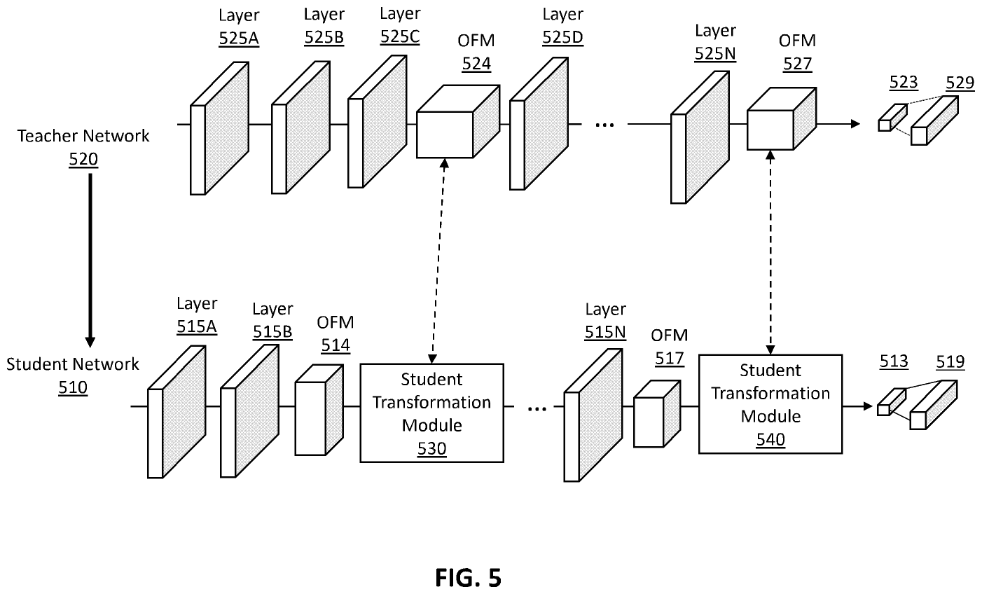

FIG. 5 illustrates another example process of training a student network 510 with a teacher network 520 through many-to-one knowledge injection, in accordance with various embodiments. The student network 510 may be provided by the student network generator 230. The formation of the teacher network 520 may be done by the teacher network generator 240. For purpose of simplicity and illustration, the student network 510 includes four layers 515A-415N (collectively referred to as “student layers 515” or “student layer 515”), and the teacher network 520 includes four layers 525A-425N (collectively referred to as “teacher layers 525” or “teacher layer 525”). The student layers 515 and teacher layers 525 may be convolutional layers, self-attention layers, linear layers, or some combination thereof. In other embodiments, the student network 510 or the teacher network 520 may include more, fewer, or different layers. For instance, the student network 510 or the teacher network 520 may include additional layers arranged between, before, or after the layers shown in FIG. 5.

In some embodiments, some or all of the teacher layers 525 may be aligned with some or all of the student layers 515, or stages in the teacher network 520 may be aligned with stages in the student network 510. A stage may include one or more layers. The teacher network 520 may include more or different layers from the student network 510. The teacher network 520 has been trained. The knowledge learnt by the teacher network 520 during the training can be injected into the student network 510 through student transformation modules 530 and 540.

As shown in FIG. 5, the student transformation module 530 is inserted into the student network 510. The student transformation module 530 may be an embodiment of the student transformation module 330 in FIG. 3. In the embodiment of FIG. 5, the student transformation module 530 is placed right after the layer 515B. The layer 525B is a convolutional layer that has an output of OFM 514. The layer 525B is not the last convolutional layer in the student network 510. The student transformation module 530 can convert the OFM 514 into an expanded feature map that includes a group of segments into which knowledge from an OFM 524 in the teacher network 520 can be injected. Each segment has the same number of channels as the OFM 524 in the teacher network 520. The OFM 527 is an output of the layer 525B in the teacher network 520. The layer 525B may be aligned with the layer 515B, or a stage including the layer 525B in the teacher network 520 aligns with a stage including the layer 515B in the student network 510. The student transformation module 530 can convert the expanded feature map into a new feature map, which can be fed into the next layer (e.g., a convolutional layer) in the student network 510 for further processing.

The student transformation module 540 is also inserted into the student network 510. The student transformation module 540 may be an embodiment of the student transformation module 330 in FIG. 3. In the embodiment of FIG. 5, the student transformation module 540 is placed right after the layer 515N. The layer 525N is a convolutional layer that has an output of OFM 517. The layer 525B is the last convolutional layer in the student network 510. The student transformation module 530 can convert the OFM 517 into an expanded feature map that includes a group of segments into which knowledge from a OFM 527 in the teacher network 520 can be injected. Each segment can have the same number of channels as the OFM 527 in the teacher network 520.

The OFM 527 is an output of the layer 525N in the teacher network 520. The layer 525N may be aligned with the layer 515B, or a stage including the layer 525N in the teacher network 520 aligns with a stage including the layer 515N in the student network 510. In some embodiments, the layer 525N is the last convolutional layer in the teacher network 520. The OFM 527 can be fed into a fully-connected layer 523, which processes the OFM 527 and outputs a label 529 that represents a determination of the teacher network 520. The student transformation module 540 can convert the expanded feature map into a new feature map, which can be fed into a fully-connected layer 513 that processes the new feature map and outputs a label 519. The label 519 may represent a determination of the student network 510. It is considered that the OFMs 524 and 527 have “better knowledge” than the OFMs 514 and 517, respectively, and the “knowledge” in the OFMs 524 and 527 may be injected into the OFMs 514 and 517 in the process of training the student network 510 with the teacher network 520.

In some embodiments, the training of the student network 510 also includes a process of minimizing a difference between the label 519 and the ground-truth label of a training sample based on which the student network 510 generates the label 519. For instance, the internal parameters of the student network 510 based on modified to minimize a combination of the aggregated feature distance and the difference between the label 519 and the growth-truth label.

### Example DL Environment

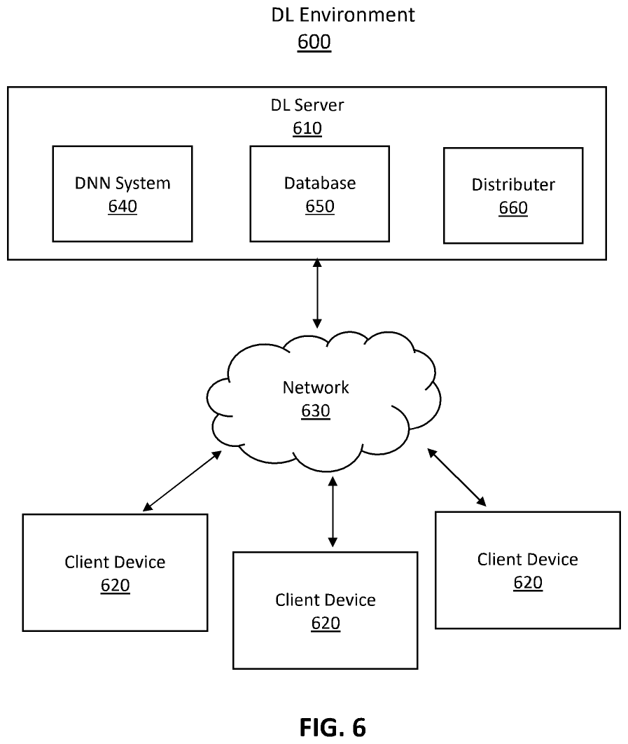

FIG. 6 illustrates a DL environment 600, in accordance with various embodiments. The DL environment 600 includes a DL server 610 and a plurality of client devices 620 (individually referred to as client device 620). The DL server 610 is connected to the client devices 620 through a network 630. In other embodiments, the DL environment 600 may include fewer, more, or different components.

The DL server 610 trains DL models using neural networks. A neural network is structured like the human brain and consists of artificial neurons, also known as nodes. These nodes are stacked next to each other in three types of layers: input layer, hidden layer(s), and output layer. Data provides each node with information in the form of inputs. The node multiplies the inputs with random weights, calculates them, and adds a bias. Finally, nonlinear functions, also known as activation functions, are applied to determine which neuron to fire. The DL server 610 can use various types of neural networks, such as DNN, recurrent neural network (RNN), generative adversarial network (GAN), long short-term memory network (LSTMN), and so on. During the process of training the DL models, the neural networks use unknown elements in the input distribution to extract features, group objects, and discover useful data patterns. The DL models can be used to solve various problems, e.g., making predictions, classifying images, and so on. The DL server 610 may build DL models specific to particular types of problems that need to be solved. A DL model is trained to receive an input and outputs the solution to the particular problem.

In FIG. 6, the DL server 610 includes a DNN system 640, a database 650, and a distributer 660. The DNN system 640 trains DNNs. The DNNs can be used to process images, e.g., images captured by autonomous vehicles, medical devices, satellites, and so on. In an embodiment, a DNN receives an input image and outputs classifications of objects in the input image. An example of the DNNs is the DNN 100 described above in conjunction with FIG. 1 or the student network 410 or 510 described above in conjunction with FIG. 4 or 5. In some embodiments, the DNN system 640 trains DNNs through knowledge distillation, e.g., dense-connection based knowledge distillation. The trained DNNs may be used on low memory systems, like mobile phones, IOT edge devices, and so on. An embodiment of the DNN system 640 is the DNN system 200 described above in conjunction with FIG. 2.

The database 650 stores data received, used, generated, or otherwise associated with the DL server 610. For example, the database 650 stores a training dataset that the DNN system 640 uses to train DNNs. In an embodiment, the training dataset is an image gallery that can be used to train a DNN for classifying images. The training dataset may include data received from the client devices 620. As another example, the database 650 stores hyperparameters of the neural networks built by the DL server 610.

The distributer 660 distributes DL models generated by the DL server 610 to the client devices 620. In some embodiments, the distributer 660 receives a request for a DNN from a client device 620 through the network 630. The request may include a description of a problem that the client device 620 needs to solve. The request may also include information of the client device 620, such as information describing available computing resource on the client device. The information describing available computing resource on the client device 620 can be information indicating network bandwidth, information indicating available memory size, information indicating processing power of the client device 620, and so on. In an embodiment, the distributer may instruct the DNN system 640 to generate a DNN in accordance with the request. The DNN system 640 may generate a DNN based on the information in the request. For instance, the DNN system 640 can determine the structure of the DNN and/or train the DNN in accordance with the request.

In another embodiment, the distributer 660 may select the DNN from a group of pre-existing DNNs based on the request. The distributer 660 may select a DNN for a particular client device 630 based on the size of the DNN and available resources of the client device 620. In embodiments where the distributer 660 determines that the client device 620 has limited memory or processing power, the distributer 660 may select a compressed DNN for the client device 620, as opposed to an uncompressed DNN that has a larger size. The distributer 660 then transmits the DNN generated or selected for the client device 620 to the client device 620.

In some embodiments, the distributer 660 may receive feedback from the client device 620. For example, the distributer 660 receives new training data from the client device 620 and may send the new training data to the DNN system 640 for further training the DNN. As another example, the feedback includes an update of the available computer resource on the client device 620. The distributer 660 may send a different DNN to the client device 620 based on the update. For instance, after receiving the feedback indicating that the computing resources of the client device 620 have been reduced, the distributer 660 sends a DNN of a smaller size to the client device 620.

The client devices 620 receive DNNs from the distributer 660 and applies the DNNs to perform machine learning tasks, e.g., to solve problems or answer questions. In various embodiments, the client devices 620 input images into the DNNs and uses the output of the DNNs for various applications, e.g., visual reconstruction, augmented reality, robot localization and navigation, medical diagnosis, weather prediction, and so on. A client device 620 may be one or more computing devices capable of receiving user input as well as transmitting and/or receiving data via the network 630. In one embodiment, a client device 620 is a conventional computer system, such as a desktop or a laptop computer. Alternatively, a client device 620 may be a device having computer functionality, such as a personal digital assistant (PDA), a mobile telephone, a smartphone, an autonomous vehicle, or another suitable device. A client device 620 is configured to communicate via the network 630. In one embodiment, a client device 620 executes an application allowing a user of the client device 620 to interact with the DL server 610 (e.g., the distributer 660 of the DL server 610). The client device 620 may request DNNs or send feedback to the distributer 660 through the application. For example, a client device 620 executes a browser application to enable interaction between the client device 620 and the DL server 610 via the network 630. In another embodiment, a client device 620 interacts with the DL server 610 through an application programming interface (API) running on a native operating system of the client device 620, such as IOS® or ANDROID™.

In an embodiment, a client device 620 is an integrated computing device that operates as a standalone network-enabled device. For example, the client device 620 includes display, speakers, microphone, camera, and input device. In another embodiment, a client device 620 is a computing device for coupling to an external media device such as a television or other external display and/or audio output system. In this embodiment, the client device 620 may couple to the external media device via a wireless interface or wired interface (e.g., an HDMI cable) and may utilize various functions of the external media device such as its display, speakers, microphone, camera, and input devices. Here, the client device 620 may be configured to be compatible with a generic external media device that does not have specialized software, firmware, or hardware specifically for interacting with the client device 620.

The network 630 supports communications between the DL server 610 and client devices 620. The network 630 may comprise any combination of local area and/or wide area networks, using both wired and/or wireless communication systems. In one embodiment, the network 630 may use standard communications technologies and/or protocols. For example, the network 630 may include communication links using technologies such as Ethernet, 8010.11, worldwide interoperability for microwave access (WiMAX), 3G, 4G, code division multiple access (CDMA), digital subscriber line (DSL), etc. Examples of networking protocols used for communicating via the network 630 may include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 630 may be represented using any suitable format, such as hypertext markup language (HTML) or extensible markup language (XML). In some embodiments, all or some of the communication links of the network 630 may be encrypted using any suitable technique or techniques.

### Example Method of Training Neural Network

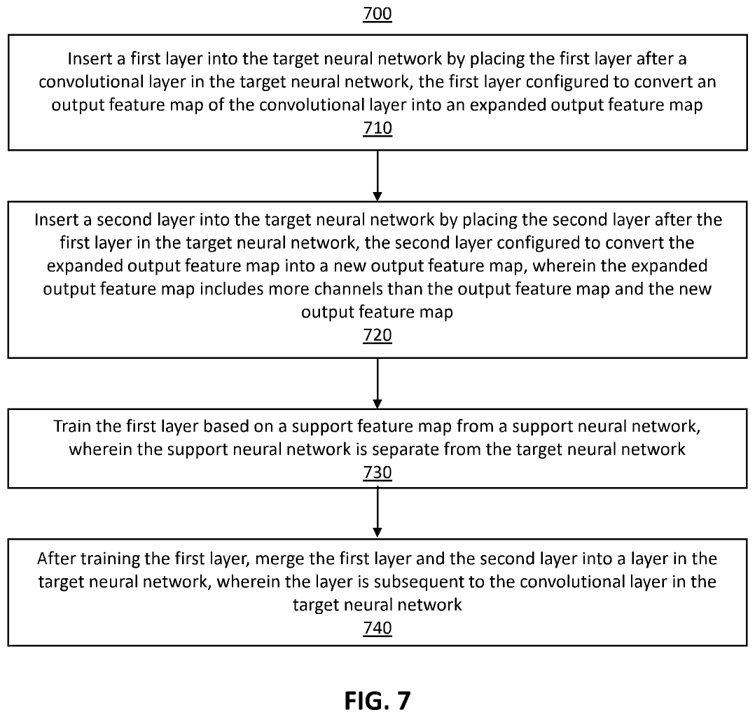

FIG. 7 is a flowchart showing a method 700 of training a DNN through knowledge distillation, in accordance with various embodiments. The method 700 may be performed by the training module 250 in FIG. 2. Although the method 700 is described with reference to the flowchart illustrated in FIG. 7, many other methods for training a DNN through dense- connection based knowledge distillation may alternatively be used. For example, the order of execution of the steps in FIG. 7 may be changed. As another example, some of the steps may be changed, eliminated, or combined.

The training module 250 inserts 710 a first layer into the target neural network by placing the first layer after a convolutional layer in the target neural network. The first layer is configured to convert an OFM of the convolutional layer into an expanded OFM. In some embodiments, the target neural network includes a sequence of convolutional layers that includes the convolutional layer. The convolutional layer is a last convolutional layer in the sequence.

The training module 250 inserts 720 a second layer into the target neural network by placing the second layer after the first layer in the target neural network. The second layer is configured to convert the expanded OFM into a new OFM. The expanded OFM includes more channels than the OFM and the new OFM.

The training module 250 trains 730 the first layer based on a support feature map from a support neural network, wherein the support neural network is separate from the target neural network. In some embodiments, the training module 250 partitions the expanded OFM into a plurality of segments. A number of channels in the segment is the same as a number of channels in the support feature map. The first layer may be configured to convert the OFM of the convolutional layer into the expanded OFM by executing a convolutional operation on the OFM and a convolutional kernel. The training module 250 may train the first layer by modifying one or more filters in the target neural network. For instance, the training module 250 may adjust the convolutional kernel to minimize a feature distance between the support feature map and a plurality of segments of the expanded feature map. In some embodiments, the training module 250 may for each respective segments of the plurality of segments, determine a segment feature distance between the respective segment and the support feature map. The feature distance may be an aggregation of segment feature distances of the plurality of segments.

After training the first layer, the training module 250 merges 740 the first layer and the second layer into a layer in the target neural network. The layer is subsequent to the convolutional layer in the target neural network. The layer may be a fully-connected layer or another convolutional layer. In some embodiments, the training module 250 inputs a training sample into the target neural network. The layer outputs a determination made based on the training sample. The training module 250 can train the first layer further based on the determination and a ground-truth label associated with the training sample.

### Example Computing Device

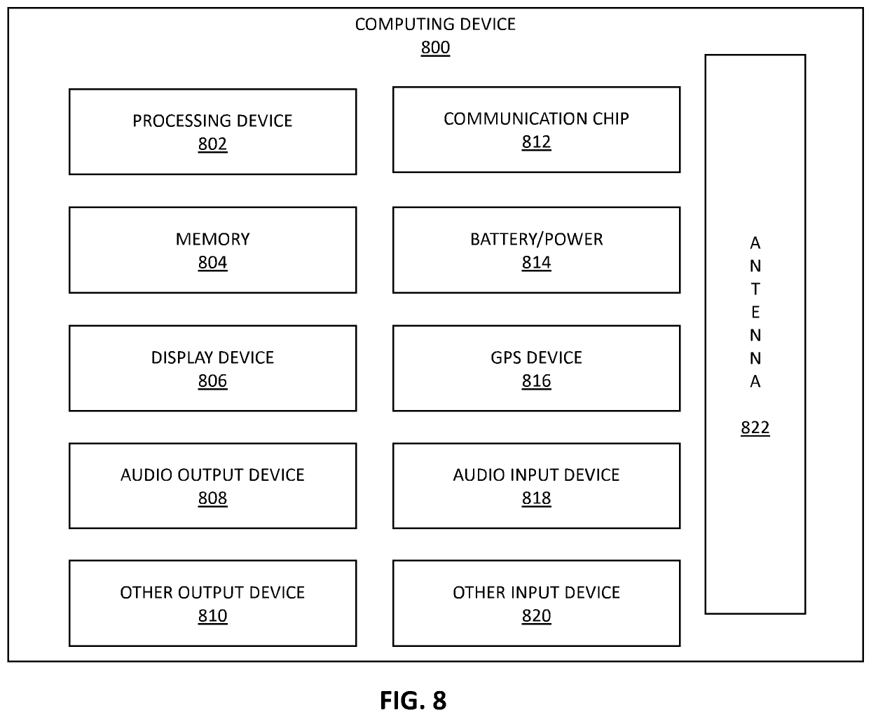

FIG. 8 is a block diagram of an example computing device 800, in accordance with various embodiments. A number of components are illustrated in FIG. 8 as included in the computing device 800, but any one or more of these components may be omitted or duplicated, as suitable for the application. In some embodiments, some or all of the components included in the computing device 800 may be attached to one or more motherboards. In some embodiments, some or all of these components are fabricated onto a single system on a chip (SoC) die. Additionally, in various embodiments, the computing device 800 may not include one or more of the components illustrated in FIG. 8, but the computing device 800 may include interface circuitry for coupling to the one or more components. For example, the computing device 800 may not include a display device 806, but may include display device interface circuitry (e.g., a connector and driver circuitry) to which a display device 806 may be coupled. In another set of examples, the computing device 800 may not include an audio input device 818 or an audio output device 808, but may include audio input or output device interface circuitry (e.g., connectors and supporting circuitry) to which an audio input device 818 or audio output device 808 may be coupled.

The computing device 800 may include a processing device 802 (e.g., one or more processing devices). As used herein, the term “processing device” or “processor” may refer to any device or portion of a device that processes electronic data from registers and/or memory to transform that electronic data into other electronic data that may be stored in registers and/or memory. The processing device 802 may include one or more digital signal processors (DSPs), application-specific ICs (ASICs), CPUs, GPUs, cryptoprocessors (specialized processors that execute cryptographic algorithms within hardware), server processors, or any other suitable processing devices. The computing device 800 may include a memory 804, which may itself include one or more memory devices such as volatile memory (e.g., DRAM), nonvolatile memory (e.g., read-only memory (ROM)), flash memory, solid state memory, and/or a hard drive. In some embodiments, the memory 804 may include memory that shares a die with the processing device 802. In some embodiments, the memory 804 includes one or more non-transitory computer-readable media storing instructions executable to perform operations for training DNNs, e.g., the method 700 described above in conjunction with FIG. 7 or the operations performed by the DNN system 200 described above in conjunction with FIG. 2 (e.g., operations performed by the training module 250). The instructions stored in the one or more non-transitory computer-readable media may be executed by the processing device 802.

In some embodiments, the computing device 800 may include a communication chip 812 (e.g., one or more communication chips). For example, the communication chip 812 may be configured for managing wireless communications for the transfer of data to and from the computing device 800. The term “wireless” and its derivatives may be used to describe circuits, devices, DNN accelerators, methods, techniques, communications channels, etc., that may communicate data through the use of modulated electromagnetic radiation through a nonsolid medium. The term does not imply that the associated devices do not contain any wires, although in some embodiments they might not.

The communication chip 812 may implement any of a number of wireless standards or protocols, including but not limited to Institute for Electrical and Electronic Engineers (IEEE) standards including Wi-Fi (IEEE 802.13 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication chip 812 may operate in accordance with a Global system for Mobile Communication (GSM), General Packet Radio Service (GPRS), Universal Mobile Telecommunications system (UMTS), High Speed Packet Access (HSPA), Evolved HSPA (E-HSPA), or LTE network. The communication chip 812 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 812 may operate in accordance with CDMA, Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 812 may operate in accordance with other wireless protocols in other embodiments. The computing device 800 may include an antenna 822 to facilitate wireless communications and/or to receive other wireless communications (such as AM or FM radio transmissions).

In some embodiments, the communication chip 812 may manage wired communications, such as electrical, optical, or any other suitable communication protocols (e.g., the Ethernet). As noted above, the communication chip 812 may include multiple communication chips. For instance, a first communication chip 812 may be dedicated to shorter-range wireless communications such as Wi-Fi or Bluetooth, and a second communication chip 812 may be dedicated to longer-range wireless communications such as global positioning system (GPS), EDGE, GPRS, CDMA, WiMAX, LTE, EV-DO, or others. In some embodiments, a first communication chip 812 may be dedicated to wireless communications, and a second communication chip 812 may be dedicated to wired communications.

The computing device 800 may include battery/power circuitry 814. The battery/power circuitry 814 may include one or more energy storage devices (e.g., batteries or capacitors) and/or circuitry for coupling components of the computing device 800 to an energy source separate from the computing device 800 (e.g., AC line power).

The computing device 800 may include a display device 806 (or corresponding interface circuitry, as discussed above). The display device 806 may include any visual indicators, such as a heads-up display, a computer monitor, a projector, a touchscreen display, a liquid crystal display (LCD), a light-emitting diode display, or a flat panel display, for example.

The computing device 800 may include an audio output device 808 (or corresponding interface circuitry, as discussed above). The audio output device 808 may include any device that generates an audible indicator, such as speakers, headsets, or earbuds, for example.

The computing device 800 may include an audio input device 818 (or corresponding interface circuitry, as discussed above). The audio input device 818 may include any device that generates a signal representative of a sound, such as microphones, microphone arrays, or digital instruments (e.g., instruments having a musical instrument digital interface (MIDI) output).

The computing device 800 may include a GPS device 816 (or corresponding interface circuitry, as discussed above). The GPS device 816 may be in communication with a satellite- based system and may receive a location of the computing device 800, as known in the art.

The computing device 800 may include an other output device 813 (or corresponding interface circuitry, as discussed above). Examples of the other output device 813 may include an audio codec, a video codec, a printer, a wired or wireless transmitter for providing information to other devices, or an additional storage device.

The computing device 800 may include an other input device 820 (or corresponding interface circuitry, as discussed above). Examples of the other input device 820 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 800 may have any desired form factor, such as a handheld or mobile computing system (e.g., a cell phone, a smart phone, a mobile internet device, a music player, a tablet computer, a laptop computer, a netbook computer, an ultrabook computer, a PDA, an ultramobile personal computer, etc.), a desktop computing system, a server or other networked computing component, a printer, a scanner, a monitor, a set-top box, an entertainment control unit, a vehicle control unit, a digital camera, a digital video recorder, or a wearable computing system. In some embodiments, the computing device 800 may be any other electronic device that processes data.

### Select Examples

The following paragraphs provide various examples of the embodiments disclosed herein.

Example 1 provides a method for training a target neural network, the method including inserting a first layer into the target neural network by placing the first layer after a convolutional layer in the target neural network, the first layer configured to convert an OFM of the convolutional layer into an expanded OFM; inserting a second layer into the target neural network by placing the second layer after the first layer in the target neural network, the second layer configured to convert the expanded OFM into a new OFM, where the expanded OFM includes more channels than the OFM and the new OFM; training the target neural network based on a support feature map from a support neural network, where the support neural network is separate from the target neural network; and after training the first layer, merging the first layer and the second layer into a layer in the target neural network, where the layer is subsequent to the convolutional layer in the target neural network.

Example 2 provides the method of example 1, where training the target neural network based on the support feature map from the support neural network includes partitioning the expanded OFM into a plurality of segments, where a number of channels in the segment is the same as a number of channels in the support feature map.

Example 3 provides the method of example 1 or 2, where the first layer is configured to convert the OFM of the convolutional layer into the expanded OFM by executing a convolutional operation on the OFM and a convolutional kernel.

Example 4 provides the method of example 3, where training the target neural network based on the support feature map from the support neural network includes modifying one or more filters in the target neural network.

Example 5 provides the method of example 4, where modifying the one or more filters in the target neural network includes adjusting values in the one or more filters to minimize a feature distance between the support feature map and a plurality of segments of the expanded feature map.

Example 6 provides the method of example 5, where adjusting the convolutional kernel based on the expanded OFM and a support feature map from a support neural network further includes for each respective segments of the plurality of segments, determining a segment feature distance between the respective segment and the support feature map, where the feature distance is an aggregation of segment feature distances of the plurality of segments.

Example 7 provides the method of any of the preceding examples, where the target neural network includes a sequence of convolutional layers that includes the convolutional layer, and the convolutional layer is a last convolutional layer in the sequence.

Example 8 provides the method of any of the preceding examples, wherein the layer is a fully-connected layer.

Example 9 provides the method of any of the preceding examples, where the layer is another convolutional layer.

Example 10 provides the method of any of the preceding examples, further including inputting a training sample into the target neural network, the layer outputting a determination made based on the training sample; and training the first layer further based on the determination and a ground-truth label associated with the training sample.

Example 11 provides one or more non-transitory computer-readable media storing instructions executable to perform operations for training a target neural network, the operations including inserting a first layer into the target neural network by placing the first layer after a convolutional layer in the target neural network, the first layer configured to convert an OFM of the convolutional layer into an expanded OFM, inserting a second layer into the target neural network by placing the second layer after the first layer in the target neural network, the second layer configured to convert the expanded OFM into a new OFM, where the expanded OFM includes more channels than the OFM and the new OFM; training the target neural network based on a support feature map from a support neural network, where the support neural network is separate from the target neural network; and after training the first layer, merging the first layer and the second layer into a layer in the target neural network, where the layer is subsequent to the convolutional layer in the target neural network.

Example 12 provides the one or more non-transitory computer-readable media of example 11, where training the target neural network based on the support feature map from the support neural network includes partitioning the expanded OFM into a plurality of segments, where a number of channels in the segment is the same as a number of channels in the support feature map.

Example 13 provides the one or more non-transitory computer-readable media of example 12, where the first layer is configured to convert the OFM of the convolutional layer into the expanded OFM by executing a convolutional operation on the OFM and a convolutional kernel.

Example 14 provides the one or more non-transitory computer-readable media of example 13, where training the target neural network based on the support feature map from the support neural network includes modifying one or more filters in the target neural network.

Example 15 provides the one or more non-transitory computer-readable media of example 14, where modifying the one or more filters in the target neural network includes adjusting values in the one or more filters to minimize a feature distance between the support feature map and a plurality of segments of the expanded feature map.

Example 16 provides the one or more non-transitory computer-readable media of example 15, where adjusting the convolutional kernel based on the expanded OFM and a support feature map from a support neural network further includes for each respective segments of the plurality of segments, determining a segment feature distance between the respective segment and the support feature map, where the feature distance is an aggregation of segment feature distances of the plurality of segments.

Example 17 provides the one or more non-transitory computer-readable media of any of examples 11-16, where the target neural network includes a sequence of convolutional layers that includes the convolutional layer, and the convolutional layer is a last convolutional layer in the sequence.

Example 18 provides the one or more non-transitory computer-readable media of any of examples 11-17, where the layer is a fully-connected layer.

Example 19 provides the one or more non-transitory computer-readable media of any of examples 11-18, where the layer is another convolutional layer.

Example 20 provides the one or more non-transitory computer-readable media of any of examples 11-19, where the operations further include inputting a training sample into the target neural network, the layer outputting a determination made based on the training sample; and training the first layer further based on the determination and a ground-truth label associated with the training sample.

Example 21 provides an apparatus for training a target neural network, the apparatus including a computer processor for executing computer program instructions; and a non-transitory computer-readable memory storing computer program instructions executable by the computer processor to perform operations including: inserting a first layer into the target neural network by placing the first layer after a convolutional layer in the target neural network, the first layer configured to convert an OFM of the convolutional layer into an expanded OFM, inserting a second layer into the target neural network by placing the second layer after the first layer in the target neural network, the second layer configured to convert the expanded OFM into a new OFM, where the expanded OFM includes more channels than the OFM and the new OFM, training the target neural network based on a support feature map from a support neural network, where the support neural network is separate from the target neural network, and after training the first layer, merging the first layer and the second layer into a layer in the target neural network, where the layer is subsequent to the convolutional layer in the target neural network.

Example 22 provides the apparatus of example 21, where training the target neural network based on the support feature map from the support neural network includes partitioning the expanded OFM into a plurality of segments, where a number of channels in the segment is the same as a number of channels in the support feature map.

Example 23 provides the apparatus of example 21 or 22, where the first layer is configured to convert the OFM of the convolutional layer into the expanded OFM by executing a convolutional operation on the OFM and a convolutional kernel.

Example 24 provides the apparatus of any of examples 21-23, where the target neural network includes a sequence of convolutional layers that includes the convolutional layer, and the convolutional layer is a last convolutional layer in the sequence.

Example 25 provides the apparatus of any of examples 21-24, where the operations further include inputting a training sample into the target neural network, the layer outputting a determination made based on the training sample; and training the first layer further based on the determination and a ground-truth label associated with the training sample.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1-25. (canceled)

26. A method for training a target neural network, the method comprising:
inserting a first layer into the target neural network by placing the first layer after a convolutional layer in the target neural network, the first layer configured to convert an output feature map of the convolutional layer into an expanded output feature map;
inserting a second layer into the target neural network by placing the second layer after the first layer in the target neural network, the second layer configured to convert the expanded output feature map into a new output feature map, wherein the expanded output feature map includes more channels than the output feature map and the new output feature map;
training the target neural network based on a support feature map from a support neural network, wherein the support neural network is separate from the target neural network; and
after training the first layer, merging the first layer and the second layer into a layer in the target neural network, wherein the layer is subsequent to the convolutional layer in the target neural network.

27. The method of claim 26, wherein training the target neural network based on the support feature map from the support neural network comprises:
partitioning the expanded output feature map into a plurality of segments,
wherein a number of channels in the segment is the same as a number of channels in the support feature map.

28. The method of claim 26, wherein the first layer is configured to convert the output feature map of the convolutional layer into the expanded output feature map by executing a convolutional operation on the output feature map and a convolutional kernel.

29. The method of claim 28, wherein training the target neural network based on the support feature map from the support neural network comprises:
modifying one or more filters in the target neural network.

30. The method of claim 29, wherein modifying the one or more filters in the target neural network comprises:
adjusting values in the one or more filters to minimize a feature distance between the support feature map and a plurality of segments of the expanded feature map.

31. The method of claim 30, wherein adjusting the convolutional kernel based on the expanded output feature map and a support feature map from a support neural network further comprises:
for each respective segments of the plurality of segments, determining a segment feature distance between the respective segment and the support feature map,
wherein the feature distance is an aggregation of segment feature distances of the plurality of segments.

32. The method of claim 26, wherein the target neural network comprises a sequence of convolutional layers that includes the convolutional layer, and the convolutional layer is a last convolutional layer in the sequence.

33. The method of claim 26, wherein the layer is a fully-connected layer.

34. The method of claim 26, wherein the layer is another convolutional layer.

35. The method of claim 26, further comprising:
inputting a training sample into the target neural network, the layer outputting a determination made based on the training sample; and
training the first layer further based on the determination and a ground-truth label associated with the training sample.

36. One or more non-transitory computer-readable media storing instructions executable to perform operations for training a target neural network, the operations comprising:
inserting a first layer into the target neural network by placing the first layer after a convolutional layer in the target neural network, the first layer configured to convert an output feature map of the convolutional layer into an expanded output feature map;
inserting a second layer into the target neural network by placing the second layer after the first layer in the target neural network, the second layer configured to convert the expanded output feature map into a new output feature map, wherein the expanded output feature map includes more channels than the output feature map and the new output feature map;
training the target neural network based on a support feature map from a support neural network, wherein the support neural network is separate from the target neural network; and
after training the first layer, merging the first layer and the second layer into a layer in the target neural network, wherein the layer is subsequent to the convolutional layer in the target neural network.

37. The one or more non-transitory computer-readable media of claim 36, wherein training the target neural network based on the support feature map from the support neural network comprises:
partitioning the expanded output feature map into a plurality of segments,
wherein a number of channels in the segment is the same as a number of channels in the support feature map.

38. The one or more non-transitory computer-readable media of claim 36, wherein the first layer is configured to convert the output feature map of the convolutional layer into the expanded output feature map by executing a convolutional operation on the output feature map and a convolutional kernel, wherein training the target neural network based on the support feature map from the support neural network comprises modifying one or more filters in the target neural network, wherein modifying the one or more filters in the target neural network comprises adjusting values in the one or more filters to minimize a feature distance between the support feature map and a plurality of segments of the expanded feature map.

39. The one or more non-transitory computer-readable media of claim 38, wherein adjusting the convolutional kernel based on the expanded output feature map and a support feature map from a support neural network further comprises:
for each respective segments of the plurality of segments, determining a segment feature distance between the respective segment and the support feature map,
wherein the feature distance is an aggregation of segment feature distances of the plurality of segments.

40. The one or more non-transitory computer-readable media of claim 36, wherein the target neural network comprises a sequence of convolutional layers that includes the convolutional layer, and the convolutional layer is a last convolutional layer in the sequence.

41. The one or more non-transitory computer-readable media of claim 36, wherein the layer is a fully-connected layer or another convolutional layer.

42. The one or more non-transitory computer-readable media of claim 36, wherein the operations further comprise:
inputting a training sample into the target neural network, the layer outputting a determination made based on the training sample; and
training the first layer further based on the determination and a ground-truth label associated with the training sample.

43. An apparatus for training a target neural network, the apparatus comprising:
a computer processor for executing computer program instructions; and
a non-transitory computer-readable memory storing computer program instructions executable by the computer processor to perform operations comprising:
inserting a first layer into the target neural network by placing the first layer after a convolutional layer in the target neural network, the first layer configured to convert an output feature map of the convolutional layer into an expanded output feature map,
inserting a second layer into the target neural network by placing the second layer after the first layer in the target neural network, the second layer configured to convert the expanded output feature map into a new output feature map, wherein the expanded output feature map includes more channels than the output feature map and the new output feature map,
training the target neural network based on a support feature map from a support neural network, wherein the support neural network is separate from the target neural network, and
after training the first layer, merging the first layer and the second layer into a layer in the target neural network, wherein the layer is subsequent to the convolutional layer in the target neural network.

44. The apparatus of claim 43, wherein training the target neural network based on the support feature map from the support neural network comprises:
partitioning the expanded output feature map into a plurality of segments,
wherein a number of channels in the segment is the same as a number of channels in the support feature map.

45. The apparatus of claim 43, wherein the first layer is configured to convert the output feature map of the convolutional layer into the expanded output feature map by executing a convolutional operation on the output feature map and a convolutional kernel.
